(19) United States
(12) Patent Application Publication
(10) Pub. No.: US 2026/0229245 A1
(43) Pub. Date: Aug. 6, 2026

(54) DONNING STATE DETECTION FOR WEARABLE ELECTRONIC DEVICES

(71) Applicant: Apple Inc., Cupertino, CA (US)

(72) Inventors: David M. TREMBLAY, Boulder, CO (US); Venu M. DUGGINENI, San Jose, CA (US); Michael J. ROCKWELL, Palo Alto, CA (US); Jerome C. TU, Saratoga, CA (US); Nicholas C. SOLDNER, Los Altos, CA (US)

(21) Appl. No.: 19/415,760

(22) Filed: Dec. 10, 2025

Related U.S. Application Data
(60) Provisional application No. 63/753,901, filed on Feb. 4, 2025.

(51) Int. Cl. G10L 25/51

(52) U.S. Cl. CPC G10L 25/51

(57) ABSTRACT

Aspects of the subject technology provide for low power operations for determining when a wearable electronic device is being worn. A microphone may be used to identify one or more acoustic indicators of whether a device is being worn, is unworn, or is in the process of being put on (donned) or taken off (doffed). An operational state may be set based on the one or more acoustic indicators.

### CROSS REFERENCE TO RELATED APPLICATIONS

This application claims the benefit of priority to U.S. Provisional Patent Application No. 63/753,901, entitled, “Donning State Detection for Wearable Electronic Devices”, filed on February 4, 2025, the disclosure of which is hereby incorporated herein in its entirety.

### TECHNICAL FIELD

The present description relates generally to electronic devices, including, for example, to donning state detection for wearable electronic devices.

### BACKGROUND

Wearable electronic devices include smartwatches and head mountable devices (HMDs) that are typically used by a user while being worn on the user’s body.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example of a wearable electronic device in accordance with one or more implementations.

FIG. 2 illustrates an example of a microphone of a wearable electronic device in proximity to a source of handling noise associated with donning or doffing the wearable electronic device in accordance with one or more implementations.

FIG. 3 illustrates an example of a microphone of a wearable electronic device in proximity to a source of friction noise associated with donning or doffing the wearable electronic device in accordance with one or more implementations.

FIG. 4 illustrates an example of a microphone of a wearable electronic device in proximity to a source of breathing noise of a user of the wearable electronic device in accordance with one or more implementations.

FIG. 5 illustrates a block diagram of an example architecture for performing donning detection operations in accordance with one or more implementations.

FIG. 6 illustrates a block diagram of an example architecture for performing doffing detection operations in accordance with one or more implementations.

FIG. 7 illustrates a flow diagram of example process for donning state detection in accordance with one or more implementations.

FIG. 8 illustrates a flow diagram of another example process doffing detection in accordance with one or more implementations.

FIG. 9 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person’s physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture an acoustic representation of the physical environment. Rather than an opaque display, a head mountable system may have a transparent or translucent display. The transparent or translucent display may have a medium through which light representative of images is directed to a person’s eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person’s retina. Projection systems also may be configured to project virtual objects into the physical environment, for example, as a hologram or on a physical surface.

Wearable electronic devices, such as smartwatches, head mountable devices (HMDs), and smart glasses are typically used by a user during the time the devices are worn by the user, and not used when the devices are not being worn by the user. Particularly in power-constrained devices, such as battery-powered devices (e.g., battery-powered devices with limited space for batteries), it can be beneficial to power down the device and/or components thereof when the device is removed from the user (e.g., doffed). In order to maintain the user’s privacy, it can also, or alternatively, be beneficial to lock the device (e.g., requiring a passcode or other authentication before the device can later be unlocked for use, such as when the user or another user later dons the device).

Once a device is powered down and/or locked, a user input, such as a press of a button, may be used to reactivate the device for user-authentication and/or operation of the device. However, this can be inconvenient for the user, and/or an inefficient use of device resources. In some devices, an inertial sensor (e.g., an inertial measurement unit (IMU)) can be used to sense motion of the device. The device motion can be used as an indicator that a device is being donned, which can then be used to cause reactivation of the device for user-authentication and/or operation of the device. In some devices, a proximity sensor can be used to sense when a part of the device is in contact with, or near contact with, a part of a user, in order to determine whether the device is being donned. However, continuously monitoring the motion of a device with an inertial sensor and/or a proximity sensor, even when the device is in a locked and/or powered-down state, can also be an inefficient use of device power. In devices that are particularly power constrained, continuously operating an inertial sensor and/or proximity sensor in this way can drain stored battery power that may be needed for other operations of the device.

Aspects of the subject technology can provide, for example, low power systems and methods for determining when a wearable device (e.g., a smartwatch, a head mountable device (HMD), or smart glasses) is in a worn (e.g., donned) or unworn (e.g., doffed) state and/or transitioning between a worn and unworn state. For example, using a microphone (e.g., an always-on microphone, which may be the lowest power consuming sensor on a device in some implementations), an acoustic indication of a user donning or doffing a wearable electronic device can be detected. As examples, the acoustic indication may include the sound of friction between the wearable device and the user (e.g., the user’s head, hair, finger, or other part of the user) as the user puts on (e.g., dons) the device or takes off (e.g., doffs) the device, the sound of handling noise as the user puts on the device or takes off the device, the sound of the user breathing when the device is being worn, an acoustic coupling between a speaker of the wearable device and a microphone of the wearable device, and/or an acoustic and/or vibratory coupling between an accelerometer of the wearable device and the speaker of the wearable device.

In various implementations, a wearable device may include microphones and/or other sensors that can be used in any of various combinations to detect the donning state (e.g., donned/worn or doffed/unworn) of the wearable device. In some implementations, an acoustic detection of a first donning indicator (e.g., friction or handling noise) may trigger activation and/or use of one or more other sensors (e.g., an IMU, camera, proximity sensor, or other sensor) to confirm the detection of donning. Doffing the device may trigger locking or deactivating the device without a secondary confirmation in some implementations, to help protect the user’s privacy after removing the device.

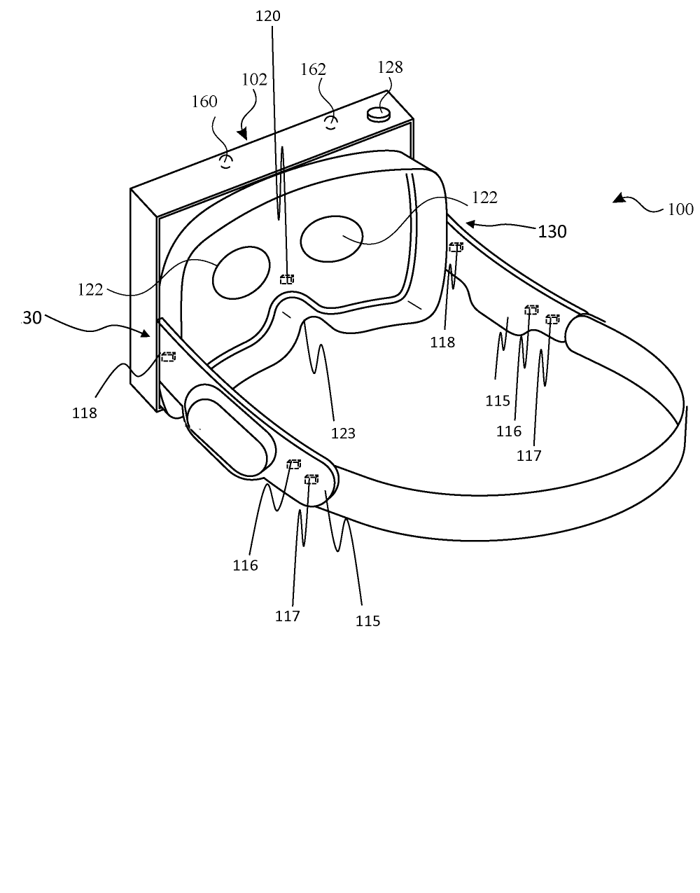

FIG. 1 illustrates an example electronic device in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In the example of FIG. 1, an electronic device 100 includes one or more microphones, such as microphones 116, microphones 118, and microphone 120. In the example of FIG. 1, the microphones 116 are located in portions of the electronic device 100 that are configured to be located at or near an ear of a user, when the electronic device 100 is worn by the user. In the example of FIG. 1, microphones 118 are included in portions of the electronic device 100 that are configured to be located at or near a hinge or connection point 130 of the electronic device 100. For example, the hinge or connection points 130 may be points at which a mounting feature 115 meets and/or secures to a frame 102 (e.g., a housing) of the electronic device 100. As examples, the mounting features 115 may be implemented as a strap for passing around the head of a user or an arm of the user, an arm configured for sitting on an ear of the user, and/or other features for securing the electronic device 100 to the user. In the example of FIG. 1, a microphone 120 is included in a portion of the electronic device 100 that is configured to be located at or near a nose of a user of the electronic device 100 (e.g., located within or near a nose bridge 123 of the electronic device). Although two microphones 116, two microphones 118, and one microphone 120 are shown in FIG. 1, it is appreciated that the electronic device 100 may include two, three, more than three, or generally any number of microphones that may be disposed at or near the locations of the user’s ears, the locations of one or more hinge or connection points, the location of the user’s nose, and/or other locations within or on the electronic device 100.

The electronic device 100 may be implemented as, for example, a wearable device such as a smartwatch, a smart band, a headset device, wired or wireless headphones, a smart ring (e.g., for wearing on a user’s finger), one or more wired or wireless earbuds (or any in-ear, against the ear or over-the-ear device), an HMD, smart glasses, and/or the like. In the example of FIG. 1, the electronic device 100 is depicted as a head-mountable display (HMD) device configured to be worn on the user’s head (e.g., and over the user’s eyes), and to provide virtual reality (VR), augmented reality (AR), mixed reality (MR), etc. experiences (e.g., XR experiences) for the user. As illustrated in FIG. 1, the mounting features 115 may be implemented as straps that may form or be a part of a retention assembly configured to wrap around a user’s head to hold a display having one or more lenses 122 against the face of the user. In various implementations, the lenses may be configured to project display images from a display of the electronic device 100 into the user’s eyes, and/or to allow light from the physical environment around the electronic device 100 to pass through to the user’s eyes.

In the example of FIG. 1, the electronic device 100 includes one or more speakers, such as speakers 117. In the example of FIG. 1, the speakers 117 are located in portions of the electronic device 100 that are configured to be located at or near an ear of a user, when the electronic device 100 is worn by the user. Although two speakers 117 are shown in FIG. 1, it is appreciated that the electronic device 100 may include two, three, more than three, or generally any number of speakers that may be disposed at or near the locations of the user’s ears, the locations of one or more hinge or connection points, and/or other locations within or on the electronic device 100.

In at least one example, the electronic device 100 may including an input component 128 (e.g., a button, a dial, or a crown). As illustrated in FIG. 1, the electronic device 100 may include one or more cameras 160 (e.g., infrared cameras, visible light cameras, monochrome images, color images, etc.), and/or one or more sensors 162 (e.g., LIDAR sensors, radar sensors, depth sensors, time-of-flight sensors, inertial sensors, accelerometers, gyroscopes, magnetometers, thermistors, and/or other sensors). In one or more implementations, the cameras 160 and/or the sensors 162 may be used to generate a video stream of the physical environment around the electronic device 100 for display by the display unit (e.g., in combination with virtual content overlaid on the video view of the physical environment). In the example of FIG. 1, the sensors 162 are depicted as being located in the frame 102 of the electronic device 100. However, any of various ones of the sensors 162 can be located in any of various locations within the frame 102 and/or the mounting features 115.

For example, in these implementations, image data from the cameras 160 and/or sensor data from the sensors 162 may be used to generate a representation (e.g., a three-dimensional representation) of the physical environment. The representation of the physical environment can be used by the electronic device to provide display content and/or spatialized audio content that is perceived, by a user, to originate from, reside within, and/or interact with the physical environment.

In one or more other implementations, a display unit mounted in the frame 102 may be transparent or partially transparent to allow a direct view of the physical environment (e.g., in combination with virtual content overlaid in the path of the direct view of the physical environment). In one or more implementations, the electronic device 100 may be operable (e.g., using the input component 128) to switch from an augmented or mixed reality display environment in which some or all of the physical environment is visible, to a virtual reality display environment in which the user’s view of the physical environment is blocked by the display unit, and a virtual environment is displayed by the display unit.

As shown, the electronic device 100 may include a pair of lenses 122 in one or more implementations. In one or more implementations, the lenses 122 may be aligned with a pair of corresponding display screens (e.g., a pair of arrays of display pixels with associated control circuitry for operating the display pixels), such that, when a user dons the electronic device 100 in the HMD implementation of FIG. 1, the light from the display screens is focused into the eyes of the user in a way that causes display content, displayed on the display screens, to be perceived by the user as being located at various three-dimensional locations, away from the display screens, such as in a three-dimensional virtual environment or in at various three-dimensional locations in a physical environment of the user (e.g., if the display screens also display a view of the physical environment of the user, such as in an augmented or mixed reality environment). In one or more implementations, the lenses 122 may be transparent or partially transparent to allow a user of the electronic device 100 to view the physical environment directly through the lenses (e.g., with or without virtual content overlaid on the view of the physical environment).

Although not shown in FIG. 1, electronic device 100 may include memory, one or more processors, input/output interfaces, and/or one or more wireless interfaces, such as one or more near-field communication (NFC) radios, WLAN radios, Bluetooth radios, Zigbee radios, cellular radios, and/or other wireless radios. Electronic device 100 may be, and/or may include all or part of, the electronic system discussed below with respect to FIG. 9.

As discussed herein, it may be desirable to be able to detect when a user puts the electronic device 100 on (e.g., dons the electronic device 100) and/or takes the electronic device 100 off (e.g., doffs the electronic device 100). In some use cases, the electronic device 100 may be in a sleep state or other powered-down or inactive state at the time that the user dons the device. In these states, one or more of the sensors of the device may also be powered off or otherwise inactive. In accordance with aspects of the subject disclosure, one or more microphones may be used to detect one or more acoustic indicators that the device is being donned (or doffed).

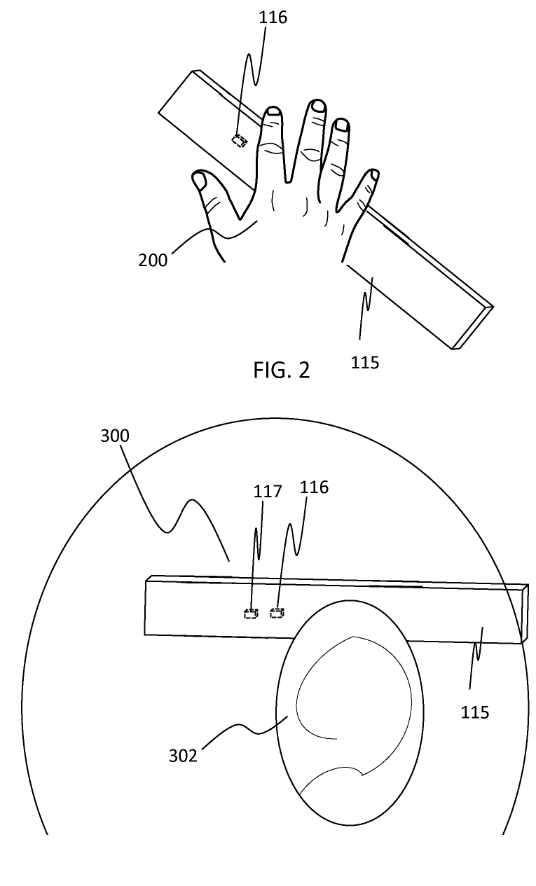

For example, as illustrated in FIG. 2, a user may contact, grab, pick up, and/or otherwise handle a structure, such as the mounting feature 115, of the electronic device 100 (e.g., with their hand 200) in order to put on, or don, the device. For example, in an implementation in which the electronic device 100 is implemented as an HMD, the user may grab (e.g., with their hand 200) a strap of the HMD in order to place the strap over their head. As another example, in an implementation in which the electronic device 100 is implemented as smart glasses (e.g., including a pair of arms connected to a frame holding lenses 122, and in which sensors, cameras, and/or circuitry can be disposed), the user may grab and/or extend an arm of the smart glasses (e.g., with their hand 200) in order to slide the arm behind the user’s ear.

As shown in FIG. 2, a microphone 116 may be located in the mounting feature 115 at or near the location at which a user might grab or otherwise handle the mounting feature 115. In this way, the microphone 116 may be configured and/or positioned to generate a microphone signal that includes a representation of the handling noise. This microphone signal generated by the microphone 116 may be used to identify an indicator that indicates that the electronic device 100 is being donned by the user (e.g., by providing the microphone signal to a machine learning model at the electronic device 100 that has been trained to identify a donning indicator from handling noise in a microphone signal). One or more machine learning models at the electronic device 100 may also be trained to identify a doffing indicator from handling noise in a microphone signal from the microphone 116. For example, handling noise associated with doffing may be different from the handling noise associated with donning. For example, when doffing a device from the user’s head, the user may grab the mounting feature 115 in a location that is different from the location at which the user typically grabs when the device when it is resting on a table, chair, or the floor.

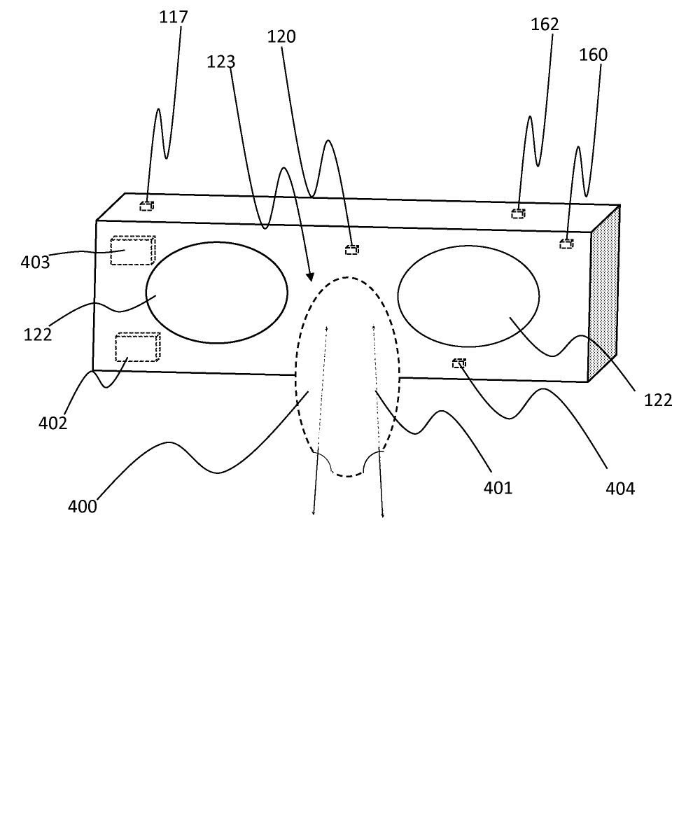

As another example, as illustrated in FIG. 3, when donning the electronic device 100, the user may slide or otherwise move the mounting feature 115 against their head 300, ear 302, and/or other portions of the user’s body (e.g., hair on the user’s head). For example, in an implementation in which the electronic device 100 is implemented as an HMD, the user may slide the strap of the HMD down over their head and/or ear, in order to place the strap over their head. As another example, in an implementation in which the electronic device 100 is implemented as smart glasses, the user may slide or otherwise move an arm of the smart glasses along the side(s) of their head, hair, and/or ear, to place the arm in position to sit behind the user’s ear 302, as shown in FIG. 3.

In the example of FIG. 3, the microphone 116 (e.g., and/or one or more of the sensors 162, such as an accelerometer or accelophone) that is located in the mounting feature 115 may be located at or near the location at which the mounting feature 115 may slide or otherwise move along the user’s head, hair, and/or ear. In this way, the microphone 116 may be configured and/or positioned to generate a microphone signal that includes a representation of the noise of friction between the mounting feature and the user (e.g., while the electronic device 100 is being actively donned or doffed, or while the electronic device 100 is donned and makes small motions relative to the user’s head, skin, and/or hair due to motion of the user’s head and/or body). This microphone signal generated by the microphone 116 may be used to identify an indicator that indicates that the electronic device 100 is in a donned state or is being donned by the user (e.g., by providing the microphone signal to a machine learning model at the electronic device 100 that has been trained to identify a donning indicator from friction noise between a portion of an electronic device and a portion of a body of the user). One or more machine learning models at the electronic device 100 may also be trained to identify a doffing indicator from friction noise (e.g., friction noise associated with doffing, which may be different from the friction noise associated with donning, such as due to moving over the user’s hair, finger, or other body part in a different direction) in a microphone signal from the microphone 116.

In the example of FIG. 3, or more of the sensors 162, such as an accelerometer or accelophone (e.g., an accelerometer used as a contact microphone) may also be used to detect and/or confirm that the electronic device 100 is in a donned state or is transitioning from a donned state to a doffed state or from a doffed state to a donned state. For example, an accelerometer signal from an accelerometer of the electronic device 100 may include one or more indicators of a donned state or a donning state, such as a representation of a bone-conducted portion of a voice of the user, a representation of a chewing activity of the user, and/or a representation of on-body (e.g., on-head) movement of the electronic device 100 relative to the body (e.g., head) of the user (e.g., representations of vibrations caused by scratching as the electronic device 100 moves over skin and/or hair). For example, because the accelerometer detects a voice of the user through vibrations of the electronic device 100 itself when the user is speaking and the electronic device 100 is in a donned state (e.g., and would not detect the user’s speech if the electronic device 100 is not in contact with the user), speech detected by the accelerometer can be a strong indicator that the electronic device 100 is in a donned state.

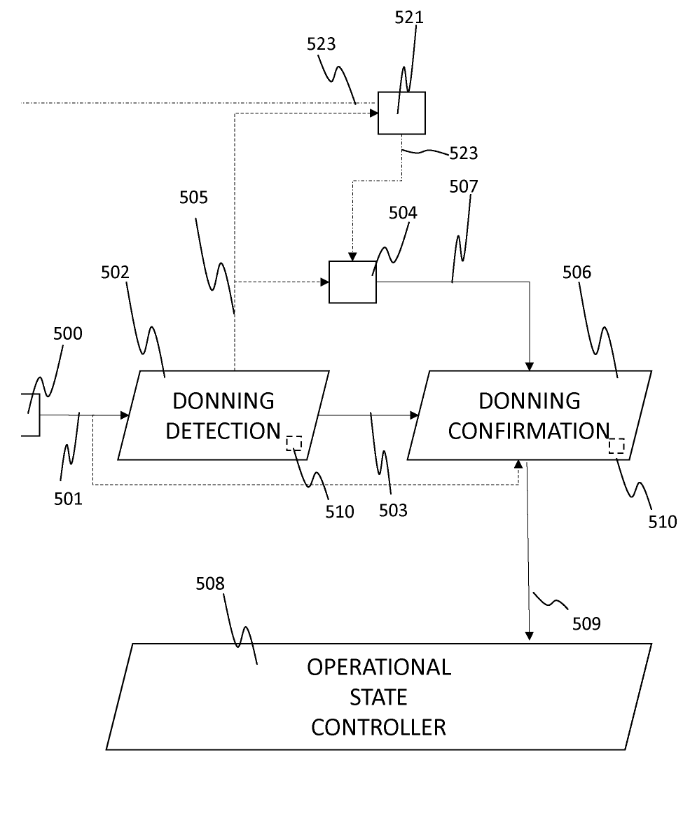

As another example, as illustrated in FIG. 4, when the electronic device 100 is in a worn state (e.g., donned), such as being worn on the user’s face (e.g., with lenses 122 aligned with the user’s eyes, and the frame 102 resting on the user’s nose 400), the user’s breathing may cause air 401 to pass through the user’s nasal cavities near a portion of the electronic device 100 that sits on the user’s nose 400. In the example of FIG. 4, the microphone 120 that is located in the frame 102 of the electronic device 100 may be located at or near the nose bridge 123. In this way, the microphone 120 may be configured and/or positioned to generate a microphone signal that includes a representation of the breathing noise from the air 401 breathed by the user. The microphone 120 may also be used to capture the sound of blood flow under the user’s skin when the electronic device 100 is worn (e.g., in a donned state) by the user. This microphone signal generated by the microphone 120 may be used to identify an indicator that indicates that the electronic device 100 is in a worn (e.g., donned) state (e.g., by providing the microphone signal to a machine learning model at the electronic device 100 that has been trained to identify a donning state from breathing noise and/or blood flow sounds). This microphone signal generated by the microphone 120 may be used to identify an indicator that indicates that the electronic device 100 is in an unworn (e.g., doffed) state, such as in the absence of breathing noise and/or blood flow sounds.

In one or more implementations, one or more donning indicators detected using the microphones 116, 118, and/or 120 and/or other sensors of the electronic device 100 may be used to determine how to set an operational state of the electronic device 100. As examples, the operational state may include an active state, an inactive state, a locked state, an unlocked state, a limited access state, a powered state, an unpowered or powered-down state, a low power state, a full power state, or the like.

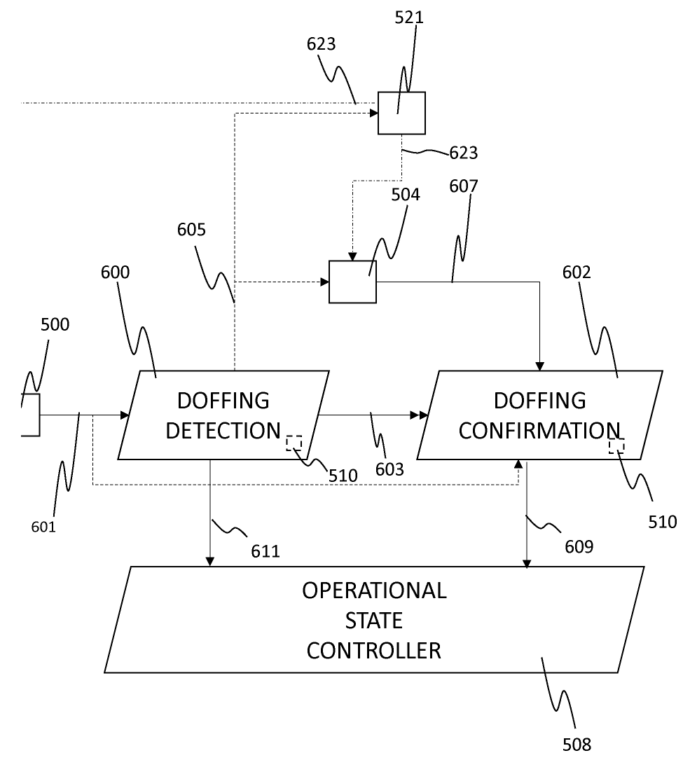

FIG. 5 illustrates an example process flow for setting an operational state of an electronic device based on donning indicators determined using microphone signals. For example, FIG. 5 illustrates an example architecture that may be implemented by the electronic device 100 in accordance with one or more implementations of the subject technology. For explanatory purposes, portions of the architecture of FIG. 5 are described as being implemented by the electronic device 100 of FIG. 1, such as by a processor and/or memory of the electronic device; however, appropriate portions of the architecture may be implemented by any other wearable electronic device. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Various portions of the architecture of FIG. 5 can be implemented in software, firmware, and/or hardware, including by one or more processors and a memory device containing instructions, which when executed by the processor cause the processor to perform the operations described herein. For example, in FIG. 5, the rectangular boxes may indicate that a microphone 500 and a sensor 504 may be hardware components, and the trapezoidal boxes may indicate that the donning detection block 502, the donning confirmation block 506, and/or the operational state controller 508 may be implemented in software, including by execution of instructions by one or more processors and a memory device containing the instructions, which when executed by the processor cause the processor to perform the operations described herein.

In the example of FIG. 5, one or more microphones, such as the microphone 500 (e.g., one or more of the microphones 116, 118, and/or 120 of the electronic device 100) may generate a microphone signal 501 that includes representations of one or more sounds generated at or near the electronic device (e.g., handling noise as described in connection with FIG. 2, friction noise as described in connection with FIG. 3, and/or breathing noise as described in connection with FIG. 4). For example, the microphone 500 may be one of the microphones of the device (e.g., microphone 116) that remains active (e.g., always on) when other microphones and other sensor of the device are inactive or powered off.

As shown, the microphone signal 501 may be provided (e.g., raw or following one or more pre-processing, filtering, or other audio processing) to a donning detection block 502. The donning detection block 502 may be configured to detect a first donning indicator (also referred to a first indicator or a first wearing state indicator) in the microphone signal, and generate an output 503 that indicates whether the first donning indicator is detected. As examples, the first donning indicator may include handling noise (e.g., handling noise that is characteristic of handling during donning, as described in connection with FIG. 2) represented in the microphone signal 501, friction noise (e.g., friction noise that is characteristic of donning, as described in connection with FIG. 3) represented in the microphone signal 501, breathing noise (e.g., breathing noise that is characteristic of a device that is being worn, and/or that is characteristic of a particular user, as described in connection with FIG. 4) represented in the microphone signal 501, chewing noise represented in the microphone signal 501, voice sounds represented in the microphone signal 501, and/or blood flow sounds represented in the microphone signal 501.

As examples, the donning detection block 502 may be implemented as deterministically programmed instructions for detecting the first donning indicator in the microphone signal 501, or as a machine learning model. For example, the donning detection block 502 may be implemented as a machine learning model (e.g., a neural network or other machine learning architecture) that has been trained (e.g., by adjusting one or more weights and/or other parameters of the machine learning model based on a cost function or a loss function that compares training outputs of the machine learning model to known training outputs, the known training outputs including known donning states for each of multiple training microphone signals that have been provided to the machine learning model as training inputs) to generate the output 503 responsive to receiving the microphone signal 501. For example, the output 503 may include an indicator of whether the first donning indicator has been detected, and/or may include a donning state (e.g., worn or donned, unworn or doffed, being donned, or being doffed).

As shown, in one or more implementations, the output 503 may be provided to a donning confirmation block 506. For example, the output 503 may trigger the donning confirmation block 506 to perform another donning detection operation (e.g., a donning confirmation operation) to determine (e.g., confirm) whether the device is being donned or is in a donned state. As shown, the donning confirmation block 506 may receive a sensor signal 507 from a sensor 504, and may perform its donning detection operation using the sensor signal 507. For example, the sensor 504 may be an implementation of the sensor 404 of FIG. 4. For example, the sensor 404 may be a higher power sensor (e.g., a sensor, such as an IMU, an accelerometer, or a camera, which consumes more power per unit time during which the sensor is being operated) than the microphone 500. As shown, in one or more implementations, the donning detection block 502 may also generate an activation signal 505 that activates the sensor 504. In this way, the higher power sensor (e.g., sensor 504) may remain in an inactive state until the donning detection block 502 detects the first donning indicator. Upon activation, the sensor 504 may provide the sensor signal 507 to the donning confirmation block 506.

The donning confirmation block 506 may detect a second donning indicator using the sensor signal 507. For example, the sensor 504 may include an inertial sensor (e.g., an accelerometer), and the second donning indicator may be motion of the device, represented in the sensor signal 507, that indicates a donning motion being performed by the user or indicates a donned state of the device. As another example, the sensor 504 may include an inertial sensor (e.g., an accelerometer), and the second donning indicator may include a bone-conducted portion of a voice of a user of the device, a blood flow sound, a breathing sound, a chewing sound, or an on-body motion sound represented in the sensor signal 507 that indicates a donning motion being performed by the user or indicates a donned state of the device. As another example, the sensor 504 may include a camera, and the second donning indicator may be an image or a portion of the user, represented in the sensor signal 507, that indicates that the device is moving into, or is in a donned position relative to the user. As another example, the sensor 504 may include a proximity sensor, and the second donning indicator may include an indication, represented in the sensor signal 507, that one or more portions of the electronic device 100 are proximal to (e.g., within a few inches, centimeters, millimeters, or in contact with) the user, or are moving into proximity of the user. As another example, the sensor 504 may include another microphone (e.g., one or more of microphones 118 and/or 120), and the second donning indicator may include an indication, represented in the sensor signal 507, of breathing noise of the user.

As examples, the donning confirmation block 506 may be implemented as deterministically programmed instructions for detecting the second donning indicator in the sensor signal 507, or as a machine learning model. For example, the donning confirmation block 506 may be implemented as a machine learning model (e.g., a neural network or other machine learning architecture) that has been trained (e.g., by adjusting one or more weights and/or other parameters of the machine learning model based on a cost function or a loss function that compares training outputs of the machine learning model to known training outputs, the known training outputs including known donning states for each of multiple training sensor signals that have been provided to the machine learning model as training inputs) to generate the output 509 responsive to receiving the sensor signal 507.

As shown, in one or more implementations, the donning confirmation block 506 may also receive the microphone signal 501. In these implementations, the donning confirmation block 506 may determine whether the second donning indicator is detected based on the sensor signal 507 and the microphone signal 501 (e.g., by providing both the sensor signal 507 and the microphone signal 501 to a machine learning model that has been trained to detect a second donning indicator based on microphone signals and sensor signals).

In one or more implementations, a donning confirmation operation performed by the donning confirmation block 506 may include operating a speaker, such as a speaker 521 of the electronic device 100 (e.g., an implementation of the speaker(s) 117 of FIGS. 1, 3, and/or 4). For example, responsive to detecting the first donning indicator, the donning detection block 502 may also provide the activation signal 505 (or another activation signal) to the speaker 521 to activate the speaker 521 and/or cause the speaker 521 to generate a donning confirmation output 523 (e.g., an audible chime). To the user, this donning confirmation output 523 from the speaker 521 may be perceived as merely confirming to the user that the device has detected itself being donned. However, as shown, the donning confirmation output 523 may also be detected by the microphone 500 and/or the sensor 504. In these implementations, the microphone signal 501 and/or the sensor signal 507 may include a representation of the donning confirmation output 523 from the speaker 521. Because the acoustic coupling between the speaker 521 and the microphone 500, and the (e.g., acoustic and/or vibratory) coupling between the speaker 521 and the sensor 504 when the electronic device 100 is in a donned state will be different from the acoustic coupling between the speaker 521 and the microphone 500 and the (e.g., acoustic and/or vibratory) coupling between the speaker 521 and the sensor 504, respectively, when the electronic device 100 is in a doffed state, the representation of the donning confirmation output 523 from the speaker 521 in the microphone signal 501 and/or the sensor signal 507 can be used by the donning confirmation block 506 to confirm whether the electronic device 100 is in the donned state or the doffed state. For example, the representation of the donning confirmation output 523 in the microphone signal 501 and/or the sensor signal 507 may be a donned-specific representation that indicates that the electronic device 100 is in a donned state, or a doffed-specific representation that indicates that the electronic device 100 is in a doffed state.

For example, the donned-specific representation may have an amplitude, a phase, and/or a frequency profile that corresponds to (e.g., matches, such as to within a range) a previously measured amplitude, phase, and/or frequency profile of the donning confirmation output obtained while the device was in a known donned state (e.g., during manufacturing or commissioning of the device). For example, with respect to the microphone signal 503, in a donned state of the electronic device 100, the presence of the user’s body in close proximity to the speaker 521 and/or the microphone 500 can increase (e.g., by reflecting some of the donning confirmation output 523 from the speaker 521 toward the microphone 500) the amplitude of the donning confirmation output 523 in the microphone signal (e.g., relative to the amplitude in the absence of reflections from a user’s body in a doffed state) or may decrease (e.g., by absorbing some of the donning confirmation output 523 from the speaker 521 before that portion of the donning confirmation output 523 reaches the microphone 500) the amplitude of the donning confirmation output 523 in the microphone signal (e.g., relative to the amplitude in the absence of absorption by a user’s body in a doffed state) depending on the arrangement of the microphone (s) and speaker(s) of the device. Accordingly, for each arrangement of speaker(s) and/or microphone(s), a donned-specific amplitude range can be stored for later comparisons during a donning confirmation operation. Similarly, reflections and/or absorptions of portions of the donning confirmation output 523 by a user’s body in a donned state of the electronic device 100 can affect the relative phases with which multiple microphones of the device receive the donning confirmation output, and/or (e.g., by absorbing or reflecting some frequencies more or less than other frequencies, in a way that is specific to human skin or hair) affect the frequency profile of the portion of the donning confirmation output that is received at the microphone 500.

As another example, with respect to the sensor signal 507, in a donned state of the electronic device 100, the presence of the user’s body in contact with potions of the housing of the electronic device 100 can increase (e.g., by providing another vibration path between the speaker 521 and the sensor 504) the amplitude of the donning confirmation output 523 in the sensor signal (e.g., relative to the amplitude in the absence of contact with a user’s body in a doffed state) or may decrease (e.g., by damping a vibration path between the speaker 521 and the sensor 504) the amplitude of the donning confirmation output 523 in the sensor signal (e.g., relative to the amplitude in the absence of damping by a user’s body in a doffed state) depending on the arrangement of the sensor(s) and speaker(s) of the device. Accordingly, for each arrangement of speaker(s) and/or sensor(s), a donned-specific amplitude range can be stored for later comparisons during a donning confirmation operation. Similarly, additional conduction paths and/or damping effects on portions of the donning confirmation output 523 due to contact with a user’s body in a donned state of the electronic device 100 can affect the relative phases with which multiple sensors of the device receive the donning confirmation output, and/or (e.g., by conducting and/or damping some frequencies more or less than other frequencies, in a way that is specific to human skin or hair) affect the frequency profile of the portion of the donning confirmation output that is received at the sensor 504.

As shown, the donning confirmation block 506 may generate an output 509 that is provided to an operational state controller 508. In one or more implementations, the operational state controller 508 may be provided as a part of an operating system of the electronic device 100. The output 509 may include an indication that the electronic device 100 is in a worn (e.g., donned) state, or in an unworn (e.g., doffed) state. The operational state controller 508 may then set the operational state of the electronic device 100 according to the worn or unworn state that is indicated in the output 509. For example, in a use case in which the output 509 indicates that the electronic device 100 is in a worn (e.g., donned) state or is being donned, the operational state controller 508 may set the operational state of the electronic device to an active state, an unlocked state, a powered state such as a full power state, or the like. In this way, the device can be powered on and/or activated at the time the user intends to use the device, without requiring the user to provide an input to the device using buttons, touch sensors, or the like.

In other use cases in which the output 509 indicates that the electronic device 100 is in an unworn (e.g., doffed) state or is being doffed, the operational state controller 508 may set the operational state of the electronic device to an inactive state, a locked state, an unpowered state such as a low power state or an off state, or the like. In this way, power consumption may be reduced when the device is not being worn, and/or access to the device can be limited or prevented while the device is not being worn.

In one or more implementations, the electronic device 100 may store (with the explicit permission of the user) a breath print 510 of an authorized user. For example, the breath print may be a representation of one or more characteristic features of the breath sounds of the authorized user. In one or more implementations, the electronic device 100 (e.g., the donning detection block 502 and/or the donning confirmation block 506) may identify the authorized user by comparing the microphone signal 501 from the microphone 500 and/or one or more other microphone signals from one or more other microphones (e.g., one or more microphones 120 at or near the nose bridge of the electronic device 100) to the breath print 510. If the authorized user in identified using the breath print 510, the donning detection block 502 and/or the donning confirmation block 506 may responsively include an indication of the identification of the authorized user, and the operational state controller 508 may unlock and/or provide access to authorized user functionality of the electronic device 100 (e.g., in addition to powering on and/or activating the device).

The operations of the donning detection block 502 of FIG. 5 may be performed by the electronic device 100 when, for example, the device is in an inactive or powered-down state, to detect when the electronic device 100 is in the process of being put on (e.g., is being donned). In some implementations, the donning confirmation block 506 may confirm that the device is being put on, and/or may confirm that the donning process has been completed and the device has been put on (e.g., has been donned, and/or is in a donned or worn state). In some implementations, the output 503 of the donning detection block 502 may be provided directly to the operational state controller 508, without performing (e.g., or while performing in parallel) the operations of the donning confirmation block 506). In use cases in which the electronic device 100 is in the inactive or powered down state, and no donning indicators are detected by the donning detection block 502 or the donning confirmation block 506, the output 503 and/or the output 509 may indicate that the electronic device is in a doffed state, and the operational state controller 508 may keep the operational state of the electronic device 100 unchanged.

The donning detection operations of FIG. 5 may thus be able to determine when the electronic device 100 remains in a previously known doffed state. In one or more implementations, the electronic device 100 may also perform doffing-specific operations to determine when the device is being doffed (e.g., after the device has previously been determined to be in a worn/donned state).

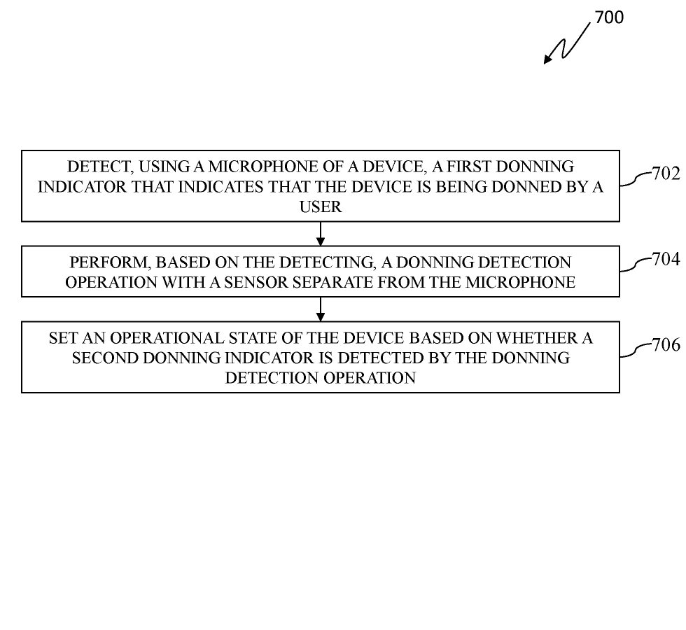

For example, FIG. 6 illustrates an example process flow for setting an operational state of an electronic device based on doffing indicators determined using microphone signals. For example, FIG. 6 illustrates an example architecture that may be implemented by the electronic device 100 in accordance with one or more implementations of the subject technology. For explanatory purposes, portions of the architecture of FIG. 6 are described as being implemented by the electronic device 100 of FIG. 1, such as by a processor and/or memory of the electronic device; however, appropriate portions of the architecture may be implemented by any other wearable electronic device. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Various portions of the architecture of FIG. 6 can be implemented in software, firmware, and/or hardware, including by one or more processors and a memory device containing instructions, which when executed by the processor cause the processor to perform the operations described herein. For example, in FIG. 6, the rectangular boxes may indicate that a microphone 500 and a sensor 504 may be hardware components, and the trapezoidal boxes may indicate that the doffing detection block 600, the doffing confirmation block 602, and/or the operational state controller 508 may be implemented in software, including by execution of instructions by one or more processors and a memory device containing the instructions, which when executed by the processor cause the processor to perform the operations described herein.

In the example of FIG. 6, one or more microphones, such as the microphone 500 (e.g., one or more of the microphones 116, 118, and/or 120 of the electronic device 100) may generate a microphone signal 601 responsive to sound generated at or near the electronic device (e.g., handling noise as described in connection with FIG. 2, friction noise as described in connection with FIG. 3, and/or breathing noise as described in connection with FIG. 4). As shown, the microphone signal 601 may be provided (e.g., raw or following one or more pre-processing, filtering, or other audio processing) to a doffing detection block 600. The doffing detection block 600 may be configured to detect a first doffing indicator (also referred to as a doffing indicator) in the microphone signal, and generate an output 603 that indicates whether the first doffing indicator is detected. As examples, the first doffing indicator may include a sound resulting from friction between the device and the user (e.g., as the user begins sliding the mounting feature 115 over their head, out from behind their ear(s), and/or off of their finger), or an absence of breath sounds (e.g., breathing noise) and/or blood flow sounds in the microphone signal (e.g., due to the microphone(s) 120) being removed from proximity of the user’s nose 400).

As examples, the doffing detection block 600 may be implemented as deterministically programmed instructions for detecting the first doffing indicator in the microphone signal 601, or as a machine learning model. For example, the doffing detection block 600 may be implemented as a machine learning model (e.g., a neural network or other machine learning architecture) that has been trained (e.g., by adjusting one or more weights and/or other parameters of the machine learning model based on a cost function or a loss function that compares training outputs of the machine learning model to known training outputs, the known training outputs including known doffing states for each of multiple training microphone signals that have been provided to the machine learning model as training inputs) to generate the output 603 responsive to receiving a microphone signal as input.

As shown, in one or more implementations, the output 603 may be provided to a doffing confirmation block 602. For example, the output 603 may trigger the doffing confirmation block 602 to perform another doffing detection operation (e.g., a doffing confirmation operation) to determine (e.g., confirm) whether the device is being taken off (e.g., doffed) by the user. As shown, the doffing confirmation block 602 may receive a sensor signal 607 from the sensor 504, and may perform its doffing detection operation using the sensor signal 607. As shown, in one or more implementations, the doffing detection block 600 may also generate an activation signal 605 that activates the sensor 504. Upon activation, the sensor 504 may provide the sensor signal 607 to the doffing confirmation block 602. However, in some use cases, the sensor 504 may already be active when the doffing detection operations of doffing detection block 600 are performed.

The doffing confirmation block 602 may detect a second doffing indicator using the sensor signal 607. For example, the sensor 504 may include an inertial sensor, and the second doffing indicator may be a motion of the device, represented in the sensor signal 607, that indicates a doffing motion of the device being performed by the user, or a cessation of a breathing feature, a blood flow feature, a chewing feature, a head-motion feature, or a user speech feature in the sensor signal 607, that indicates a doffing motion of the device being performed by the user. As another example, the sensor 504 may include a camera, and the second doffing indicator may be an image or a portion of the user, represented in the sensor signal 607, that indicates that the device is moving away from a donned position relative to the user. As another example, the sensor 504 may include a proximity sensor, and the second doffing indicator may include an indication, represented in the sensor signal 607, that one or more portions of the electronic device 100 are no longer proximal to (e.g., within a few inches, centimeters, millimeters, or in contact with) the user or are moving away from proximity of the user. As another example, the sensor 504 may include another microphone (e.g., one or more of microphones 118 and/or 120), and the second doffing indicator may include an indication, represented in the sensor signal 607, of an absence of breathing noise from the user.

As examples, the doffing confirmation block 602 may be implemented as deterministically programmed instructions for detecting the second doffing indicator in the sensor signal 607, or as a machine learning model. For example, the doffing confirmation block 602 may be implemented as a machine learning model (e.g., a neural network or other machine learning architecture) that has been trained (e.g., by adjusting one or more weights and/or other parameters of the machine learning model based on a cost function or a loss function that compares training outputs of the machine learning model to known training outputs, the known training outputs including known doffing states for each of multiple training sensor signals that have been provided to the machine learning model as training inputs) to generate the output 609 responsive to receiving the sensor signal 607 as input.

As shown, in one or more implementations, the doffing confirmation block 602 may also receive the microphone signal 601. In these implementations, the doffing confirmation block 602 may determine whether the second doffing indicator is detected based on the sensor signal 607 and the microphone signal 601 (e.g., by providing both the sensor signal 607 and the microphone signal 601 to a machine learning model that has been trained to detect a second doffing indicator based on microphone signals and sensor signals).

In one or more implementations, a doffing confirmation operation performed by the doffing confirmation block 602 may include operating the speaker 521 of the electronic device 100. As shown, in one or more implementations, responsive to detecting the first doffing indicator, the doffing detection block 600 may also provide the activation signal 605 (or another activation signal) to the speaker 521 to activate the sensor speaker 521 to generate a doffing confirmation output 623 (e.g., one or more beeps or other sounds that indicate, to the user, that the device has detected itself being doffed).

To the user, this doffing confirmation output 623 from the speaker 521 may be perceived as merely confirming to the user that the device has detected itself being doffed. However, as shown, the doffing confirmation output 623 may also be detected by the microphone 500 and/or the sensor 504. In these implementations, the microphone signal 601 and/or the sensor signal 607 may include a representation of the doffing confirmation output 623 from the speaker 521. Because the acoustic coupling between the speaker 521 and the microphone 500, and the (e.g., acoustic and/or vibratory) coupling between the speaker 521 and the sensor 504 when the electronic device 100 is in a donned state will be different from the acoustic coupling between the speaker 521 and the microphone 500, and the (e.g., acoustic and/or vibratory) coupling between the speaker 521 and the sensor 504 when the electronic device 100 is in a doffed state, the representation of the doffing confirmation output 623 from the speaker 521 in the microphone signal 601 and/or the sensor signal 607 can be used by the doffing confirmation block 602 to confirm whether the electronic device 100 is in the donned state or the doffed state.

For example, the representation of the doffing confirmation output 623 in the microphone signal 501 and/or the sensor signal 507 may be a donned-specific representation that indicates that the electronic device 100 is in a donned state, or a doffed-specific representation that indicates that the electronic device 100 is in a doffed state.

For example, the donned-specific representation of the doffing confirmation output 623 in the microphone signal 501 and/or the sensor signal 507 may have an amplitude, a phase, and/or a frequency profile that corresponds to (e.g., matches, such as to within a range) a previously measured amplitude, phase, and/or frequency profile of the doffing confirmation output obtained while the device was in a known donned state (e.g., during manufacturing or commissioning of the device). For example, with respect to the microphone signal 603, in a donned state of the electronic device 100, the presence of the user’s body in close proximity to the speaker 521 and/or the microphone 500 can increase (e.g., by reflecting some of the doffing confirmation output 623 from the speaker 521 toward the microphone 500) the amplitude of the doffing confirmation output 623 in the microphone signal (e.g., relative to the amplitude in the absence of reflections from a user’s body in a doffed state) or may decrease (e.g., by absorbing some of the doffing confirmation output 623 from the speaker 521 before that portion of the doffing confirmation output 623 reaches the microphone 500) the amplitude of the doffing confirmation output 623 in the microphone signal (e.g., relative to the amplitude in the absence of absorption by a user’s body in a doffed state) depending on the arrangement of the microphone (s) and speaker(s) of the device. Accordingly, for each arrangement of speaker(s) and/or microphone(s), a donned-specific amplitude range can be stored for later comparisons during a doffing confirmation operation. Similarly, reflections and/or absorptions of portions of the doffing confirmation output 623 by a user’s body in a donned state of the electronic device 100 can affect the relative phases with which multiple microphones of the device receive the doffing confirmation output, and/or (e.g., by absorbing or reflecting some frequencies more or less than other frequencies, in a way that is specific to human skin or hair) affect the frequency profile of the portion of the doffing confirmation output that is received at the microphone 500.

As another example, with respect to the sensor signal 507, in a donned state of the electronic device 100, the presence of the user’s body in contact with potions of the housing of the electronic device 100 can increase (e.g., by providing another vibration path between the speaker 521 and the sensor 504) the amplitude of the doffing confirmation output 623 in the sensor signal (e.g., relative to the amplitude in the absence of contact with a user’s body in a doffed state) or may decrease (e.g., by damping a vibration path between the speaker 521 and the sensor 504) the amplitude of the doffing confirmation output 623 in the sensor signal (e.g., relative to the amplitude in the absence of damping by a user’s body in a doffed state) depending on the arrangement of the sensor(s) and speaker(s) of the device. Accordingly, for each arrangement of speaker(s) and/or sensor(s), a donned-specific amplitude range can be stored for later comparisons during a doffing confirmation operation. Similarly, additional conduction paths and/or damping effects on portions of the doffing confirmation output 623 due to contact with a user’s body in a donned state of the electronic device 100 can affect the relative phases with which multiple sensors of the device receive the doffing confirmation output, and/or (e.g., by conducting and/or damping some frequencies more or less than other frequencies, in a way that is specific to human skin or hair) affect the frequency profile of the portion of the doffing confirmation output that is received at the sensor 504.

As shown in FIG. 6, in one or more implementations, the doffing detection block 600 may provide an output 611 (e.g., the same output as the output 603, or a different output) directly to the operational state controller 508. For example, the output 611 may indicate whether the first doffing indicator has been detected, and/or may indicate whether the device is in a worn or unworn state. In one or more implementations, the output 611 may be provided to the operational state controller 508 without performing, or in parallel with performing, the doffing confirmation operations of the doffing confirmation block 602. In this way, the operational state controller 508 may be immediately informed of a doffing detection, in order to take action to protect the privacy of the user of the electronic device 100 (e.g., by locking or restricting access to device data and/or functionality) when the user removes the electronic device 100 from being worn on their person.

The output 609 and/or the output 611 may include an indication that the electronic device 100 is in an unworn (e.g., doffed) state. The operational state controller 508 may then set the operational state of the electronic device 100 according to the unworn state that is indicated in the output 609. For example, in a use case in which the output 609 or the output 611 indicates that the electronic device 100 is in an unworn (e.g., doffed) state or is being doffed, the operational state controller 508 may set the operational state of the electronic device to an inactive state, a locked state (e.g., that prevents access to one or more features of the device), an unpowered state such as a lower power state or powered-off state, or the like. In this way, power consumption may be reduced when the device is not being worn, and/or access to the device can be limited or prevented while the device is not being worn. In one or more implementations, the doffing detection block 600 and/or the doffing confirmation block 602 may compare breath sounds represented in the microphone signal 601 to the breath print 510, and may indicate to the operational state controller, when the breath sounds do not correspond to an authorized user, so that the operational state controller can lock or restrict access to private information of the authorized user. In this way, user privacy can be protected by ensuring that access to the device data and/or functionality is limited and/or prevented as soon as an initial indication that an authorized user has doffed the device is detected.

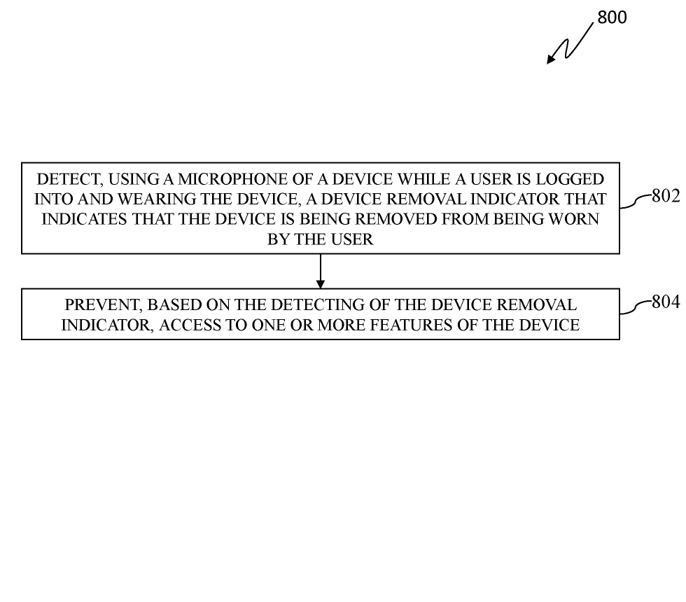

FIG. 7 illustrates a flow diagram of an example process for detecting donning of a wearable electronic device, in accordance with one or more implementations. For explanatory purposes, the process 700 is primarily described herein with reference to the electronic device 100 of FIG. 1. However, the process 700 is not limited to the electronic device 100 of FIG. 1, and one or more blocks (or operations) of the process 700 may be performed by one or more other components and other suitable devices. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

In the example of FIG. 7, at block 702, an electronic device (e.g., electronic device 100) may detect (e.g., by a donning detection block 502 performing a first donning detection operation, such as a wearing state detection operation), using a microphone (e.g., microphone 500, which may include one more of microphones 116, 118, and/or 120) of a device, a first donning indicator that indicates that the device is being donned by a user.

In one or more implementations, the microphone (e.g., one or more of microphones 116) may be disposed in a portion of the device that is configured to be proximal to an ear (e.g., ear 302) of the user when the device is being worn by the user. In one or more implementations, the first donning indicator may include handling noise (e.g., as detected using the microphone 116 or 118) resulting from contact between the user (e.g., a hand 200 of the user) and the device. In one or more implementations, the first donning indicator may include a sound resulting from friction (e.g., as detected using the microphone 116) between the user (e.g., a head 300, an ear 302, hair, and/or finger of the user) and the device.

In one or more other implementations, the microphone (e.g., microphone 120) may be disposed in a portion of the device that is configured to be proximal to a nose (e.g., nose 400) of the user when the device is being worn by the user. For example, the first donning indicator may include a breathing sound (e.g., of air 401) from the user (e.g., as detected using the microphone 120).

At block 704, the device may perform, based on the detecting, a donning detection operation (e.g., a second donning detection operation, such as a second wearing state detection operation or s donning confirmation operation performed by a donning confirmation block 506) with a sensor (e.g., sensor 504) separate from the microphone. For example, the sensor (e.g., sensor 504) may include another microphone (e.g., one or more of the microphones 118 and/or 120), an inertial sensor (e.g., inertial sensor 404), a camera (e.g., camera 160), or a proximity sensor (e.g., sensor 162). In one or more implementations, the device may also activate the sensor of the device responsive to the detecting.

At block 706, the device (e.g., an operational state controller 508 at the device) may set an operational state of the device based on whether a second donning indicator is detected by the donning detection operation. For example, performing the donning detection operation may include detecting the second donning indicator, and setting the operational state of the device may include activating the device. As another example, performing the donning detection operation may include detecting the second donning indicator, and setting the operational state of the device may include: performing an authentication operation for the user; and setting the device to an unlocked state. As another example, performing the donning detection operation may include detecting the second donning indicator, and setting the operational state of the device may include providing access to device functionality for the user.

In one or more implementations, activating the device may include powering on the device (e.g., powering on a processor, such as the processor 402 using power from a battery, such as the battery 403). Activating the device may include providing power (e.g., from the battery 403) to a display, such as to display a login screen or a home screen. Activating the device may include operating one or more sensors (e.g., cameras) to obtain biometric authentication information.

In one or more implementations, the sensor may include an inertial sensor (e.g., inertial sensor 404), and the second donning indicator may include a detected donning motion of the device. In one or more implementations, the sensor may include a camera (e.g., camera 160), and the second donning indicator may include an image of a portion of the user. In one or more implementations, the sensor may include another microphone (e.g., microphone 120) of the device, the other microphone disposed in a portion of the device that is configured to be proximal to a nose (e.g., nose 400) of the user when the device is being worn by the user, and the second donning indicator may include a breathing sound (e.g., of air 401) from the user. In one or more implementations, the sensor may include an inertial sensor, and the second donning indicator may include one or more of: a detected voice of the user, a chewing sound, or an on-body movement sound.

In one or more implementations, the donning detection operation may also include generating, with a speaker (e.g., speaker 117 or speaker 521) of the device and responsive to the detecting of the first donning indicator at block 702, a donning confirmation output (e.g., donning confirmation output 523), and the second donning indicator may include a donned-specific representation of the donning confirmation output of the speaker in at least one of a microphone signal of the microphone or a sensor signal of the sensor. For example, the donned-specific representation may have an amplitude, a phase, and/or a frequency profile that corresponds to (e.g., matches, such as to within a range) a previously measured amplitude, phase, and/or frequency profile of the donning confirmation output obtained while the device was in a known donned state (e.g., during manufacturing or commissioning of the device).

In one or more implementations, the process 700 may also include identifying the user by comparing an acoustic signal (e.g., microphone signal 501) from the microphone (or another microphone) of the device to a stored breath print (e.g., breath print 510) of the user.

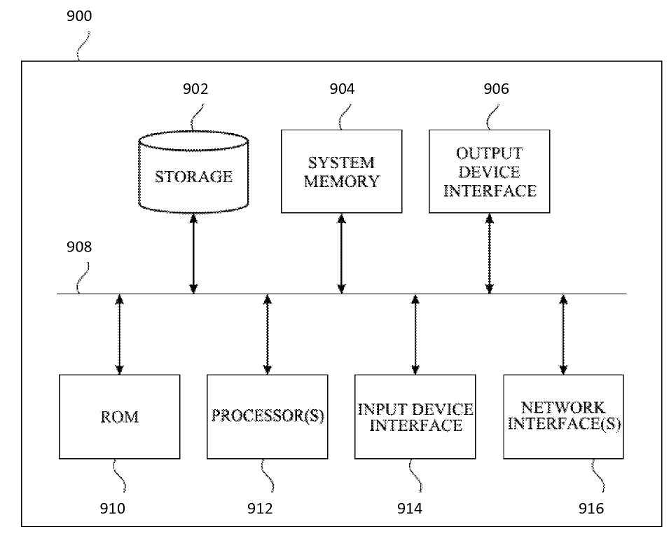

FIG. 8 illustrates a flow diagram of an example process for detecting doffing of a wearable electronic device, in accordance with one or more implementations. For explanatory purposes, the process 800 is primarily described herein with reference to the electronic device 100 of FIG. 1. However, the process 800 is not limited to the electronic device 100 of FIG. 1, and one or more blocks (or operations) of the process 800 may be performed by one or more other components and other suitable devices. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

In the example of FIG. 8, at block 802, an electronic device (e.g., electronic device 100) may detect (e.g., by the doffing detection block 600), using a microphone (e.g., one or more of the microphones 116, 118, and/or 120) of the device while a user is logged into and wearing the device (e.g., and the device is active), a device removal indicator (e.g., a doffing indicator) that indicates that the device is being removed from being worn by the user (e.g., is being doffed). For example, the device removal indicator may include an absence of breathing noise in the microphone signal. As other examples, the device removal indicator may include friction noise (e.g., friction noise characteristic of doffing) in the microphone signal 501, and/or handling noise (e.g., handling noise characteristic of doffing) in the microphone signal 501.

At block 804, the electronic device (e.g., the operational state controller 508, responsive to receiving the output 611 and/or the output 609) may prevent, based on the detecting of the device removal indicator, access to one or more features of the device. For example, preventing the access to one or more features of the device may include locking the device or powering down the device and/or one or more components (e.g., a display, an input component, etc.) of the device.

In one or more implementations, the device removal indicator may be a first device removal indicator, and the process 800 may also include detecting (e.g., by the doffing confirmation block 602), using the microphone or another sensor (e.g., sensor 504) of the device, a second device removal indicator (e.g., a second doffing indicator) that indicates that the device is being removed from being worn by the user. The process 800 may also include powering down (e.g., by the operational state controller) the device responsive to detecting the second device removal indicator. For example, the first device removal indicator may include a sound resulting from friction between the device and the user (e.g., as detected using one or more of the microphones 116 and/or 118), and the second device removal indicator may include an absence of breathing noise from the user (e.g., as detected using one or more microphones 120). As another example, the first device removal indicator may include a sound resulting from friction between the device and the user (e.g., as detected using one or more of the microphones 116 and/or 118), and the second device removal indicator may include a motion of the device detected using an inertial sensor (e.g., sensor 504) of the device.

In one or more implementations, the process 800 may also include generating, with a speaker (e.g., speaker 521) of the device and responsive to the detecting of the first device removal indicator, a doffing confirmation output (e.g., doffing confirmation output 623), and the second device removal indicator (e.g., second doffing indicator) may include a doffed-specific representation of the doffing confirmation output of the speaker in at least one of a microphone signal of the microphone (e.g., microphone 500) or a sensor signal of the other sensor (e.g., sensor 504).

As described above, one aspect of the present technology is the gathering and use of data available from specific and legitimate sources for processing user information in association with providing donning state detection for wearable electronic devices. The present disclosure contemplates that in some instances, this gathered data may include personal information data that uniquely identifies or can be used to identify a specific person. Such personal information data can include voice data, speech data, audio data, demographic data, location-based data, online identifiers, telephone numbers, email addresses, home addresses, data or records relating to a user’s health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for donning state detection for wearable electronic devices. Accordingly, use of such personal information data may facilitate transactions (e.g., on-line transactions). Further, other uses for personal information data that benefit the user are also contemplated by the present disclosure. For instance, health and fitness data may be used, in accordance with the user’s preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of donning state detection for wearable electronic devices, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy. s

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data.

FIG. 9 illustrates an electronic system 900 with which one or more implementations of the subject technology may be implemented. The electronic system 900 can be, and/or can be a part of, one or more of the electronic device 100 shown in FIG. 1. The electronic system 900 may include various types of computer readable media and interfaces for various other types of computer readable media. The electronic system 900 includes a bus 908, one or more processing unit(s) 912, a system memory 904 (and/or buffer), a ROM 910, a permanent storage device 902, an input device interface 914, an output device interface 906, and one or more network interfaces 916, or subsets and variations thereof.

The bus 908 collectively represents all system, peripheral, and chipset buses that communicatively connect the numerous internal devices of the electronic system 900. In one or more implementations, the bus 908 communicatively connects the one or more processing unit(s) 912 with the ROM 910, the system memory 904, and the permanent storage device 902. From these various memory units, the one or more processing unit(s) 912 retrieves instructions to execute and data to process in order to execute the processes of the subject disclosure. The one or more processing unit(s) 912 can be a single processor or a multi-core processor in different implementations.

The ROM 910 stores static data and instructions that are needed by the one or more processing unit(s) 912 and other modules of the electronic system 900. The permanent storage device 902, on the other hand, may be a read-and-write memory device. The permanent storage device 902 may be a non-volatile memory unit that stores instructions and data even when the electronic system 900 is off. In one or more implementations, a mass-storage device (such as a magnetic or optical disk and its corresponding disk drive) may be used as the permanent storage device 902.

In one or more implementations, a removable storage device (such as a floppy disk, flash drive, and its corresponding disk drive) may be used as the permanent storage device 902. Like the permanent storage device 902, the system memory 904 may be a read-and-write memory device. However, unlike the permanent storage device 902, the system memory 904 may be a volatile read-and-write memory, such as random access memory. The system memory 904 may store any of the instructions and data that one or more processing unit(s) 912 may need at runtime. In one or more implementations, the processes of the subject disclosure are stored in the system memory 904, the permanent storage device 902, and/or the ROM 910. From these various memory units, the one or more processing unit(s) 912 retrieves instructions to execute and data to process in order to execute the processes of one or more implementations.

The bus 908 also connects to the input and output device interfaces 914 and 906. The input device interface 914 enables a user to communicate information and select commands to the electronic system 900. Input devices that may be used with the input device interface 914 may include, for example, alphanumeric keyboards and pointing devices (also called “cursor control devices”). The output device interface 906 may enable, for example, the display of images generated by electronic system 900. Output devices that may be used with the output device interface 906 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 9, the bus 908 also couples the electronic system 900 to one or more networks and/or to one or more network nodes, through the one or more network interface(s) 916. In this manner, the electronic system 900 can be a part of a network of computers (such as a LAN, a wide area network (“WAN”), or an Intranet, or a network of networks, such as the Internet. Any or all components of the electronic system 900 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
detecting, using a microphone of a device, a first donning indicator that indicates that the device is being donned by a user;
performing, based on the detecting, a donning detection operation with a sensor separate from the microphone; and
setting an operational state of the device based on whether a second donning indicator is detected by the donning detection operation.

2. The method of claim 1, wherein the sensor comprises another microphone, an inertial sensor, a camera, or a proximity sensor, and wherein the method further comprises activating the sensor of the device responsive to the detecting.

3. The method of claim 1, wherein performing the donning detection operation comprises detecting the second donning indicator, and wherein setting the operational state of the device comprises activating the device.

4. The method of claim 1, wherein performing the donning detection operation comprises detecting the second donning indicator, and wherein setting the operational state of the device comprises:
performing an authentication operation for the user; and
setting the device to an unlocked state.

5. The method of claim 1, wherein performing the donning detection operation comprises detecting the second donning indicator, and wherein setting the operational state of the device comprises providing access to device functionality for the user.

6. The method of claim 1, further comprising identifying the user by comparing an acoustic signal from the microphone or another microphone of the device to a stored breath print of the user.

7. The method of claim 1, wherein the donning detection operation further comprising generating, with a speaker of the device and responsive to the detecting of the first donning indicator, a donning confirmation output, and wherein the second donning indicator comprises a donned-specific representation of the donning confirmation output of the speaker in at least one of a microphone signal of the microphone or a sensor signal of the sensor.

8. A method, comprising:
detecting, using a microphone of a device while a user is logged into and wearing the device, a device removal indicator that indicates that the device is being removed from being worn by the user; and
preventing, based on the detecting of the device removal indicator, access to one or more features of the device.

9. The method of claim 8, wherein preventing the access to one or more features of the device comprises locking the device.

10. The method of claim 9, wherein the device removal indicator comprises a first device removal indicator, and wherein the method further comprises:
detecting, using the microphone or an other sensor of the device, a second device removal indicator that indicates that the device is being removed from being worn by the user; and
powering down the device responsive to detecting the second device removal indicator.

11. The method of claim 10, further comprising generating, with a speaker of the device and responsive to the detecting of the first device removal indicator, a doffing confirmation output, and wherein the second device removal indicator comprises a doffed-specific representation of the doffing confirmation output of the speaker in at least one of a microphone signal of the microphone or a sensor signal of .

12. The method of claim 11, wherein the first device removal indicator comprises a sound resulting from friction between the device and the user, and wherein the second device removal indicator comprises an absence of breathing noise from the user.

13. The method of claim 11, wherein the first device removal indicator comprises a sound resulting from friction between the device and the user, and wherein the second device removal indicator comprises a motion of the device detected using an inertial sensor of the device.

14. A wearable device comprising:
a microphone;
a sensor; and
one or more processors configured to:
detect, using the microphone, a first indicator that indicates that the wearable device is being moved from an unworn state to a worn state;
perform a wearing state detection operation with the sensor; and
set an operational state of the wearable device based on whether a second indicator that indicates that the wearable device is being moved from the unworn state to the worn state is detected by the wearing state detection operation.

15. The wearable device of claim 14, wherein the microphone is disposed in a portion of the wearable device that is configured to be proximal to an ear of a user when the wearable device is being worn by the user.

16. The wearable device of claim 15, wherein the first indicator comprises handling noise resulting from contact between the user and the wearable device.

17. The wearable device of claim 15, wherein the first indicator comprises a sound resulting from friction between the user and the wearable device.

18. The wearable device of claim 15, wherein the sensor comprises an inertial sensor, and wherein the second indicator comprises a detected donning motion of the wearable device.

19. The wearable device of claim 15, wherein the sensor comprises an inertial sensor, and wherein the second indicator comprises one or more of: a detected voice of the user, a chewing sound, or an on-body movement sound.

20. The wearable device of claim 15, wherein the sensor comprises a camera, and wherein the second indicator comprises an image of a portion of the user.

21. The wearable device of claim 15, wherein the sensor comprises an other microphone of the wearable device, the other microphone disposed in a portion of the wearable device that is configured to be proximal to a nose of the user when the wearable device is being worn by the user, and wherein the second indicator comprises a breathing sound from the user.

22. The wearable device of claim 14, wherein the microphone is disposed in a portion of the wearable device that is configured to be proximal to a nose of a user when the wearable device is being worn by the user.

23. The wearable device of claim 22, wherein the first indicator comprises a breathing sound from the user.
